(19) United States
(12) Patent Application Publication
(10) Pub. No.: US 2013/0020795 A1
(43) Pub. Date: Jan. 24, 2013

(54) PIPE COUPLING ASSEMBLY AND METHOD FOR PREVENTING LONGITUDINAL MOVEMENT OF COUPLING RINGS

(71) Applicant: Natalino Giraldi, Bronx, NY (US)

(72) Inventor: Natalino Giraldi, Bronx, NY (US)

(73) Assignee: CONSOLIDATED EDISON COMPANY OF NEW YORK, INC., New York, NY (US)

(21) Appl. No.: 13/186,865

(22) Filed: Jul. 20, 2011

(51) Int. Cl. F16L 55/00

(52) U.S. Cl. 285/24

(57) ABSTRACT

A pipe coupling assembly for preventing longitudinal movement of first and second coupling rings disposed on first and second pipe sections is provided. The pipe coupling assembly includes a first clamping assembly disposed around a portion of an outer surface of the first pipe section and to abut against the first coupling ring. The pipe coupling assembly further includes a second clamping assembly disposed around a portion of an outer surface of the second pipe section and to abut against the second coupling ring. The pipe coupling assembly further includes a first threaded shaft coupled to both the first clamping assembly and the second clamping assembly to prevent longitudinal movement of the first and second clamping assemblies.

### BACKGROUND OF THE INVENTION

Two pipe sections are typically coupled together with a connecting pipe portion disposed around the two pipe sections with first and second coupling rings disposed around the two pipe sections and coupled to the connecting pipe portion. However, over time, the first and second coupling rings may rotate relative to the connecting pipe portion and allow the first and second coupling rings to move longitudinally relative to one another. When the first and second coupling rings move longitudinally relative to one another, the two pipe sections may not be sealed together as desired. Also, when two pipe sections are deflected due to downward forces of the two pipe sections.

The inventor herein has recognized a need for an improved pipe coupling assembly.

### SUMMARY OF THE INVENTION

A pipe coupling assembly for preventing longitudinal movement of first and second coupling rings disposed on first and second pipe sections in accordance with an exemplary embodiment is provided. The pipe coupling assembly includes a first clamping assembly configured to be disposed around a portion of an outer surface of the first pipe section and to abut against the first coupling ring. The pipe coupling assembly further includes a second clamping assembly configured to be disposed around a portion of an outer surface of the second pipe section and to abut against the second coupling ring. The pipe coupling assembly further includes a first threaded shaft coupled to both the first clamping assembly and the second clamping assembly to prevent longitudinal movement of the first and second clamping assemblies.

A method for preventing longitudinal movement of first and second coupling rings disposed on first and second pipe sections in accordance with another exemplary embodiment is provided. The method includes disposing a first clamping assembly around a portion of an outer surface of the first pipe section such that the first clamping assembly abuts against the first coupling ring. The method further includes disposing a second clamping assembly around a portion of an outer surface of the second pipe section such that the first clamping assembly abuts against the second coupling ring. The method further includes coupling a first threaded shaft to both the first clamping assembly and the second clamping assembly to prevent longitudinal movement of the first and second clamping assemblies.

### BRIEF DESCRIPTION OF THE DRAWINGS

FIG. 1 is a cross-sectional schematic of a pipe coupling assembly configured to be coupled to two pipe sections, in accordance with an exemplary embodiment;

FIG. 2 is another cross-sectional schematic of the pipe coupling assembly of FIG. 1 coupled to the two pipe sections;

FIG. 3 is an isometric view of the pipe coupling assembly of FIG. 1 coupled to the two pipe sections;

FIG. 4 is an isometric view of a clamping assembly utilized in the pipe coupling assembly of FIG. 1;

FIG. 5 is an isometric view of another clamping assembly utilized in the pipe coupling assembly of FIG. 1;

FIG. 6 is a flowchart of a method for preventing longitudinal movement of first and second coupling rings disposed on first and second pipe sections utilizing the pipe coupling assembly of FIG. 1, in accordance with another exemplary embodiment;

FIG. 7 is a schematic of an alternative clamping portion in accordance with another exemplary embodiment;

FIG. 8 is a cross-sectional schematic of the clamping portion of FIG. 7; and

FIG. 9 is an enlarged schematic of a portion of the clamping portion of FIG. 7 having a plurality of gripping portions.

### DETAILED DESCRIPTION OF THE INVENTION

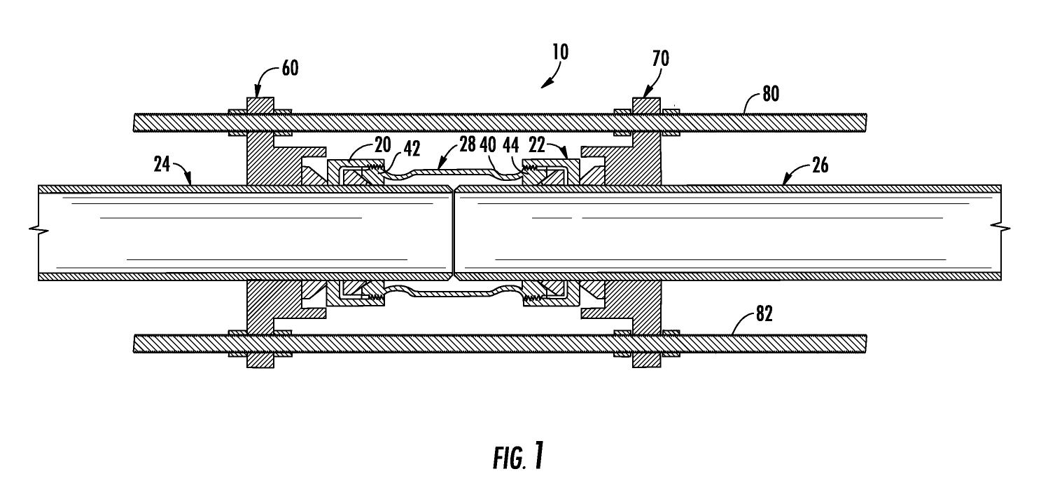

Referring to FIG. 1, a pipe coupling assembly 10 for preventing longitudinal movement of coupling rings 20, 22, disposed on pipe sections 24, 26, respectively, in accordance with an exemplary embodiment is provided. In addition to preventing longitudinal movement of the coupling rings 20, 22, the pipe coupling assembly 10 prevents deflection of pipe sections 24, 26 when a downward or upward force is applied to external surfaces of the pipe sections 24, 26.

A connecting pipe portion 28 is disposed around end portions of the pipe sections 24, 26. The connecting pipe portion 28 has a generally tubular-shaped body 40 with threaded end portions 42, 44. The coupling rings 20, 22 are disposed around end portions of the pipe sections 24, 26, respectively. The coupling rings 20, 22 are further threadably coupled to the threaded end portions 42, 44, respectively, of the connecting pipe portion 28.

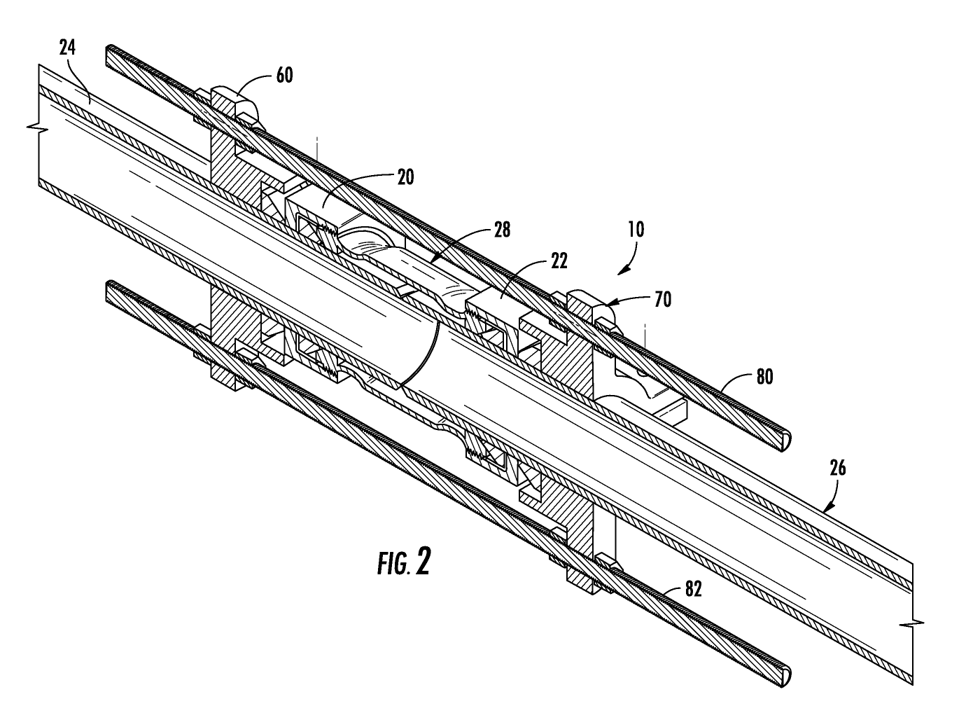

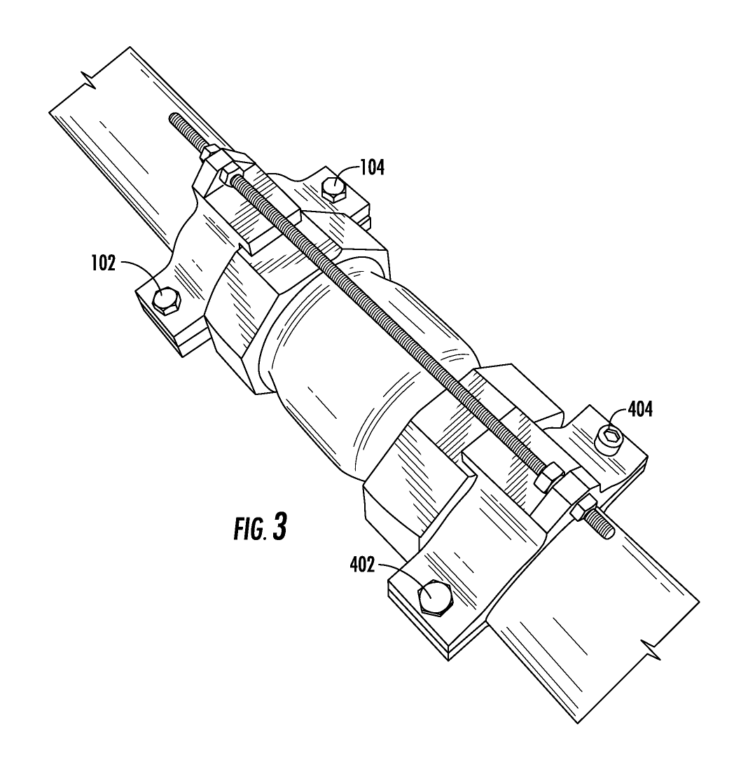

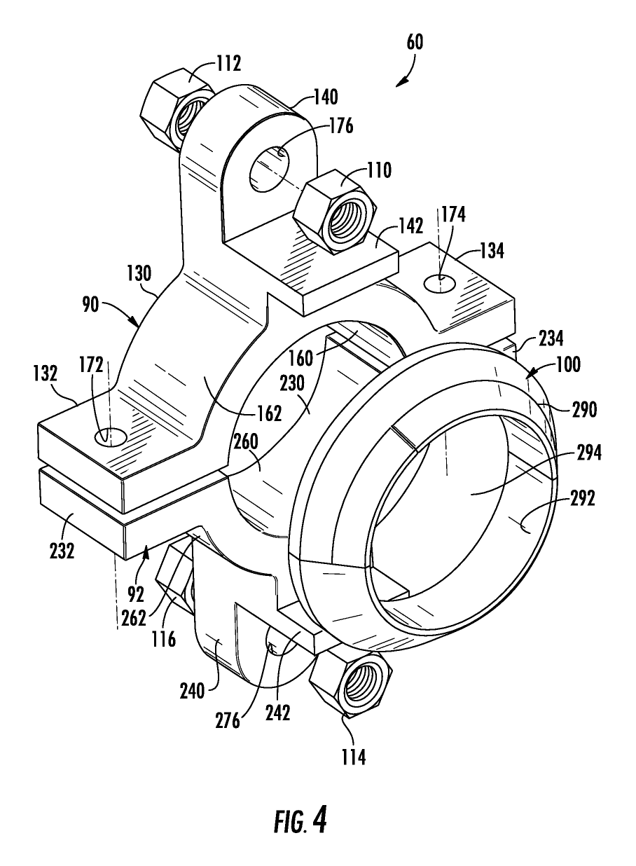

Referring to FIGS. 1-4, the pipe coupling assembly 10 includes a clamping assembly 60, a clamping assembly 70, and threaded shafts 80, 82.

Referring to FIGS. 1, 3 and 4, the clamping assembly 60 is configured to be disposed around a portion of an outer surface of the pipe section 24 and to abut against the coupling ring 20 such that the coupled ring 20 is urged against the connecting pipe portion 28. The clamping assembly 60 includes a clamping portion 90, a clamping portion 92, a ring-shaped engagement member 100, bolts 102, 104, and nuts 110, 112, 114, 116.

The clamping portion 90 has an arcuate-shaped portion 130, flanges 132, 134, a mounting portion 140, and a positioning extension 142. The flanges 132, 134 extend outwardly from opposite ends of the arcuate-shaped portion 130 and have apertures 172, 174, respectively, extending therethrough. An inner surface of the arcuate-shaped portion 130 is configured to be disposed on a portion of the outer surface of the pipe section 24. The mounting portion 140 extends outwardly from an outer surface 162 of the arcuate-shaped portion 130 and has an aperture 176 extending therethrough. The positioning extension 142 extends outwardly from the mounting portion 140 in a longitudinal direction. In one exemplary embodiment, the clamping portion 90 is constructed of steel. Of course, in an alternative embodiment, the clamping portion 90 could be constructed of other materials known to those skilled in the art.

The clamping portion 92 has an arcuate-shaped portion 230, flanges 232, 234, a mounting portion 240, and a positioning extension 242. The flanges 232, 234 extend outwardly from opposite ends of the arcuate-shaped portion 230 and each flange has an aperture extending therethrough. An inner surface of the arcuate-shaped portion 230 is configured to be disposed on a portion of the outer surface of the pipe section 24. The mounting portion 240 extends outwardly from an outer surface 262 of the arcuate-shaped portion 230 and has an aperture 276 extending therethrough. The positioning extension 242 extends outwardly from the mounting portion 240 in a longitudinal direction. In one exemplary embodiment, the clamping portion 92 is constructed of steel. Of course, in an alternative embodiment, the clamping portion 92 could be constructed of other materials known to those skilled in the art.

The ring-shaped engagement member 100 is configured to be disposed against the clamping portions 90, 92 and between the positioning extensions 142, 242. The ring-shaped engagement member 100 has a tapered outer surface 290, and an inner surface that defines an aperture 294. The aperture 294 is configured to receive the pipe section 24 therethrough. In one exemplary embodiment, the ring-shaped engagement member 100 is constructed of an elastomeric compound such as a rubber compound or a fluoroelastomer. For example, in an exemplary embodiment, the ring-shaped engagement member 100 is constructed of a fluoroelastomer sold under the trademark Viton® manufactured by DuPont Corporation. Of course, in an alternative embodiment, the ring-shaped engagement member 100 could be constructed of other materials known to those skilled in the art.

During installation, the inner surface 160 of the clamping portion 90 is disposed on an outer surface of the pipe section 24, and the inner surface 260 of the clamping portion 92 is disposed on an outer surface of the pipe section 24. Further, the flanges 132, 232 are disposed adjacent to one another such that the aperture 172 and an aperture extending through the flange 232 are aligned with one another. The bolt 102 is inserted in both the aperture 172 and the aperture extending through the flange 232 and a threaded end of the bolt 102 is coupled to a nut. Further, the flanges 134, 234 are disposed adjacent to one another such that the aperture 174 and an aperture extending through the flange 234 are aligned with one another. Further, the bolt 104 is inserted in both the aperture 174 and the aperture extending through the flange 234 and a threaded end of the bolt 104 is coupled to a nut. Further, the ring-shaped engagement member 100 is disposed against the clamping portions 90, 92 and between the positioning extensions 142, 242, and is further disposed against the coupling ring 20. Further, an end portion of the threaded shaft 80 is inserted through the aperture 176 of the mounting portion 140. Further, the nuts 110, 112 are threadably coupled to the threaded shaft 80 on opposite sides of the mounting portion 140 to couple the threaded shaft 80 to the clamping portion 90. Further, an end portion of the threaded shaft 82 is inserted through the aperture 276 of the mounting portion 240. Further, the nuts 114, 116 are threadably coupled to the threaded shaft 82 on opposite sides of the mounting portion 240 to couple the threaded shaft 82 to the clamping portion 92.

Referring to FIGS. 1, 3 and 5, the clamping assembly 70 is configured to be disposed around a portion of an outer surface of the pipe section 26 and to abut against the coupling ring 22 such that the coupled ring 22 is urged against the connecting pipe portion 28. The clamping assembly 70 includes a clamping portion 390, a clamping portion 392, a ring-shaped engagement member 400, bolts 402, 404, and nuts 410, 412, 414, 416.

The clamping portion 390 has an arcuate-shaped portion 430, flanges 432, 434, a mounting portion 440, and a positioning extension 442. The flanges 432, 434 extend outwardly from opposite ends of the arcuate-shaped portion 430 and have apertures 472, 474, respectively, extending therethrough. An inner surface of the arcuate-shaped portion 430 is configured to be disposed on a portion of the outer surface of the pipe section 26. The mounting portion 440 extends outwardly from an outer surface 462 of the arcuate-shaped portion 430 and has an aperture 476 extending therethrough. The positioning extension 442 extends outwardly from the mounting portion 440 in a longitudinal direction. In one exemplary embodiment, the clamping portion 390 is constructed of steel. Of course, in an alternative embodiment, the clamping portion 390 could be constructed of other materials known to those skilled in the art.

The clamping portion 392 has an arcuate-shaped portion 530, flanges 532, 534, a mounting portion 540, and a positioning extension 542. The flanges 532, 534 extend outwardly from opposite ends of the arcuate-shaped portion 530 and each flange has an aperture extending therethrough. An inner surface of the arcuate-shaped portion 530 is configured to be disposed on a portion of the outer surface of the pipe section 26. The mounting portion 540 extends outwardly from an outer surface 562 of the arcuate-shaped portion 530 and has an aperture 576 extending therethrough. The positioning extension 542 extends outwardly from the mounting portion 540 in a longitudinal direction. In one exemplary embodiment, the clamping portion 392 is constructed of steel. Of course, in an alternative embodiment, the clamping portion 392 could be constructed of other materials known to those skilled in the art.

The ring-shaped engagement member 400 is configured to be disposed against the clamping portions 390, 392 and between the positioning extensions 442, 542. The ring-shaped engagement member 400 has a tapered outer surface 690, and an inner surface 692 that defines an aperture 694. The aperture 694 is configured to receive the pipe section 26 therethrough. In one exemplary embodiment, the ring-shaped engagement member 400 is constructed of an elastomeric compound such as a rubber compound or a fluoroelastomer. For example, in an exemplary embodiment, the ring-shaped engagement member 400 is constructed of a fluoroelastomer sold under the trademark Viton® manufactured by DuPont Corporation. Of course, in an alternative embodiment, the ring-shaped engagement member 400 could be constructed of other materials known to those skilled in the art.

During installation, the inner surface 460 of the clamping portion 390 is disposed on an outer surface of the pipe section 26, and the inner surface 560 of the clamping portion 392 is disposed on an outer surface of the pipe section 26. Further, the flanges 432, 532 are disposed adjacent to one another such that the aperture 472 and an aperture extending through the flange 532 are aligned with one another. The bolt 402 is inserted in both the aperture 472 and the aperture extending through the flange 532 and a threaded end of the bolt 402 is coupled to a nut. Further, the flanges 434, 534 are disposed adjacent to one another such that the aperture 574 and an aperture extending through the flange 534 are aligned with one another. Further, the bolt 404 is inserted in both the aperture 574 and the aperture extending through the flange 534 and a threaded end of the bolt 404 is coupled to a nut. Further, the ring-shaped engagement member 600 is disposed against the clamping portions 390, 392 and between the positioning extensions 442, 542, and is further disposed against the coupling ring 22. Further, an end portion of the threaded shaft 80 is inserted through the aperture 476 of the mounting portion 440. Further, the nuts 410, 412 are threadably coupled to the threaded shaft 80 on opposite sides of the mounting portion 440 to couple the threaded shaft 80 to the clamping portion 390. Further, an end portion of the threaded shaft 82 is inserted through the aperture 576 of the mounting portion 540. Further, the nuts 414, 416 are threadably coupled to the threaded shaft 82 on opposite sides of the mounting portion 540 to couple the threaded shaft 82 to the clamping portion 392.

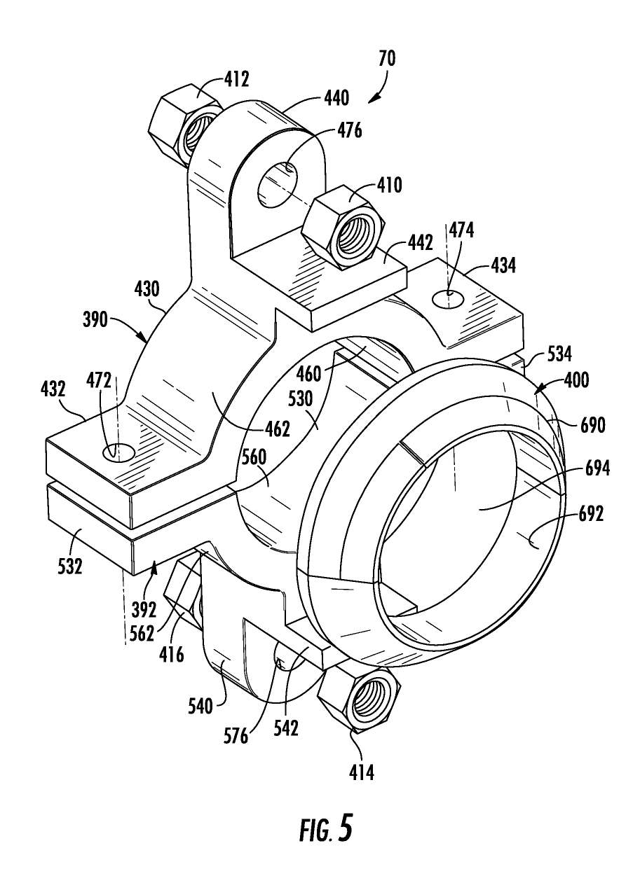

Referring to FIG. 6, a flowchart of a method for preventing longitudinal movement of the coupling rings 20, 22 disposed on the pipe sections 24, 26 and preventing deflection of pipe sections 24, 26 when a downward or upward force is applied to the pipe sections 24, 26, utilizing the pipe coupling assembly 10 in accordance with another exemplary embodiment will now be explained.

At step 700, a user disposes the clamping assembly 60 around a portion of an outer surface of the pipe section 24 such that the clamping assembly 60 abuts against the coupling ring 20 to urge the coupling ring 20 against a first end of the connecting pipe section 28.

At step 702, the user disposes the clamping assembly 70 around a portion of an outer surface of the pipe section 26 such that the clamping assembly 70 abuts against the coupling ring 22 to urge the coupling ring 22 against a second end of the connecting pipe section 28.

At step 704, the user couples the threaded shaft 80 to both the clamping assembly 60 and the second clamping assembly 70 to prevent longitudinal movement of the clamping assemblies 60, 70.

At step 706, the user couples the threaded shaft 82 to both the clamping assembly 60 and the clamping assembly 70 to prevent longitudinal movement of the clamping assemblies 60, 70.

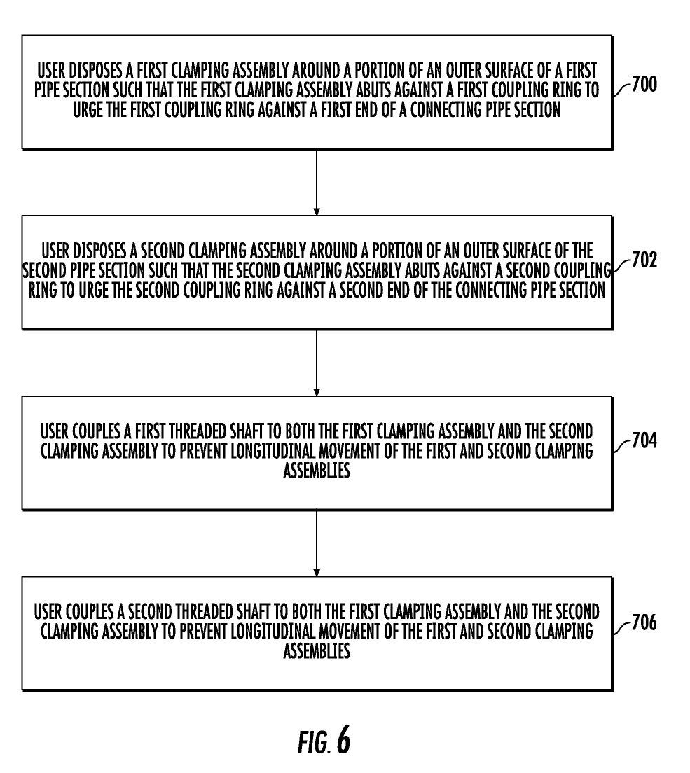

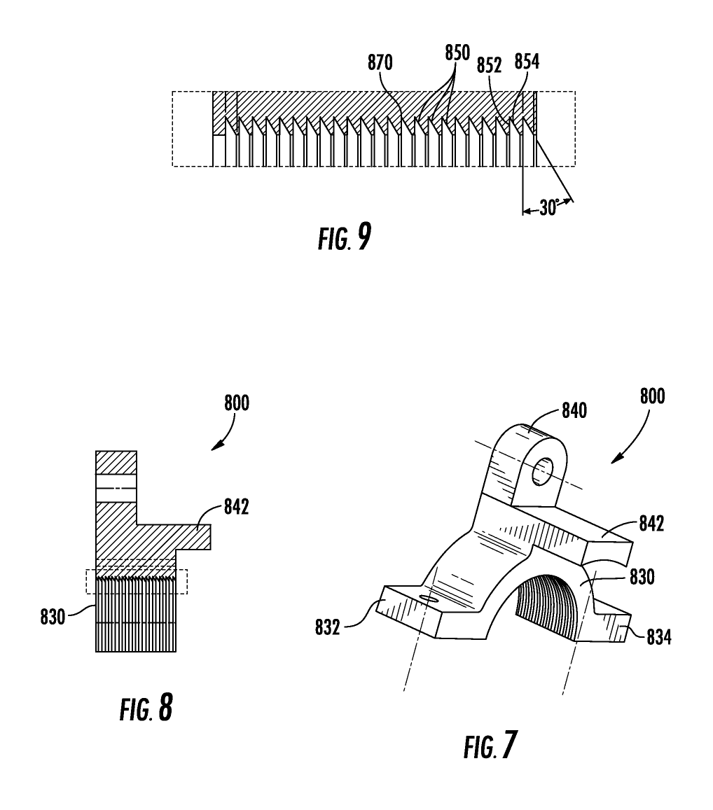

Referring to FIGS. 7-9, a clamping portion 800 in accordance with another exemplary embodiment is provided. In an alternative embodiment of the pipe coupling assembly 10, the clamping portions 90, 92 could be replaced with two clamping portions 800. The clamping portion 800 includes an arcuate-shaped portion 830, flanges 832, 834, a mounting portion 840, and a positioning portion 842. The arcuate-shaped portion 830 includes a plurality of gripping portions 850 configured to grip an external surface of a pipe section to prevent longitudinal movement of the pipe section. In an exemplary embodiment, each of the plurality of gripping portions 850 have a vertical surface 852 and a slanted surface 854. Also, the slanted surface 854 is disposed at an angle of 30 relative to the vertical surface. Each tip 870 of each of the plurality of gripping portions 850 is urged into an outer surface of a pipe section during coupling of the clamping portion 800 to the pipe section.

The pipe coupling assembly 10 and the method for preventing longitudinal movement of the coupling rings 20, 22 disposed on the pipe sections 24, 26 provide a substantial advantage over other assemblies and methods. In particular, the pipe coupling assembly 10 and method provide a technical effect of utilizing first and second clamping assemblies coupled with at least one threaded bar to prevent longitudinal movement of the coupling rings 20, 22.

What is claimed is:

1. A pipe coupling assembly for preventing longitudinal movement of first and second coupling rings disposed on first and second pipe sections, comprising:
a first clamping assembly configured to be disposed around a portion of an outer surface of the first pipe section and to abut against the first coupling ring;
a second clamping assembly configured to be disposed around a portion of an outer surface of the second pipe section and to abut against the second coupling ring; and
a first threaded shaft coupled to both the first clamping assembly and the second clamping assembly to prevent longitudinal movement of the first and second clamping assemblies.

2. The pipe coupling assembly of claim 1, further comprising a second threaded shaft coupled to both the first clamping assembly and the second clamping assembly to prevent longitudinal movement of the first and second clamping assemblies.

3. The pipe coupling assembly of claim 1, wherein the first clamping assembly comprises:
a first clamping portion having a first arcuate-shaped portion, first and second flanges extending outwardly from opposite ends of the first arcuate-shaped portion, and a first mounting portion extending outwardly from an outer surface of the first arcuate-shaped portion, an inner surface of the first arcuate-shaped portion configured to be disposed on the outer surface of the first pipe section.

4. The pipe coupling assembly of claim 3, wherein the first clamping assembly further comprises:
a second clamping portion having a second arcuate-shaped portion, third and fourth flanges extending outwardly from opposite ends of the second arcuate-shaped portion, and a second mounting portion extending outwardly from an outer surface of the second arcuate-shaped portion, an inner surface of the second arcuate-shaped portion configured to be disposed on the outer surface of the second pipe section.

5. The pipe coupling assembly of claim 4, wherein the first clamping portion further includes a first positioning extension extending outwardly from the first mounting portion, and the second clamping portion further includes a second positioning extension extending outwardly from the second mounting portion, and wherein the pipe coupling assembly further comprises:
a ring-shaped engagement member configured to be disposed against the first and second clamping portions and between the first and second positioning extensions, the ring-shaped engagement member configured to abut against the first coupling ring.

6. The pipe coupling assembly of claim 5, wherein the first flange of the first clamping portion has a first aperture extending therethrough, and the second flange of the first clamping portion has a second aperture extending therethrough, and the first mounting portion of the first mounting portion has a third aperture extending therethrough.

7. The pipe coupling assembly of claim 6, wherein the third flange of the second clamping portion has a fourth aperture extending therethrough, and the fourth flange of the second clamping portion has a fifth aperture extending therethrough, and the second mounting portion of the second clamping portion has a sixth aperture extending therethrough.

8. The pipe coupling assembly of claim 7, further comprising a first bolt, wherein the first and third flanges are disposed against one another such that the first and fourth apertures are aligned with one another, and the first bolt is disposed through the first and fourth apertures to couple the first and second clamping portions to one another.

9. The pipe coupling assembly of claim 8, further comprising a second bolt, wherein the second and fourth flanges are disposed against one another such that the second and fifth apertures are aligned with one another, and the second bolt is disposed through the second and fifth apertures to couple the first and second clamping portions to one another.

10. The pipe coupling assembly of claim 5, wherein the ring-shaped engagement member has a tapered outer surface.

11. The pipe coupling assembly of claim 1, wherein the first threaded shaft being coupled to both the first clamping assembly and the second clamping assembly prevents deflection of the first and second pipe sections when an external force is applied against external surfaces of the first and second pipe sections.

12. A method for preventing longitudinal movement of first and second coupling rings disposed on first and second pipe sections, comprising:
disposing a first clamping assembly around a portion of an outer surface of the first pipe section such that the first clamping assembly abuts against the first coupling ring;
disposing a second clamping assembly around a portion of an outer surface of the second pipe section such that the first clamping assembly abuts against the second coupling ring; and
coupling a first threaded shaft to both the first clamping assembly and the second clamping assembly to prevent longitudinal movement of the first and second clamping assemblies.

13. The method of claim 12, further comprising coupling a second threaded shaft to both the first clamping assembly and the second clamping assembly to prevent longitudinal movement of the first and second clamping assemblies.
